(19) United States
(12) Patent Application Publication
(10) Pub. No.: US 2005/0013999 A1
(43) Pub. Date: Jan. 20, 2005

(54) Luminescent nanomaterials

(76) Inventors: Gareth Wakefield, Oxford (GB); Mark Green, Oxford (GB)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/494,128

(22) PCT Filed: Nov. 1, 2002
(86) PCT No.: PCT/GB02/04975

(30) Foreign Application Priority Data
Nov. 1, 2001 (GB) 0126283.1

(51) Int. Cl. C09K 11/08; C09K 11/06; C09K 11/68

(52) U.S. Cl. 428/403; 252/301.4 R; 252/301.4 H; 252/301.4 F; 252/301.4 P; 252/301.4 S; 252/301.5; 252/301.16; 252/301.6 S; 427/212

(57) ABSTRACT

A process is disclosed for preparing water soluble particles of a luminescent material which is a rare earth material, a doped compound semi-conductor or a doped inorganic compound which comprises coating particles of said luminescent material, either during production of the particles, or subsequently, with an organic acid or Lewis base such that the surface of the coating possesses one or more reactive groups.

This invention relates to luminescent nanomaterials which are particularly useful in biological tagging.

The use of common organic dyes for tagging presents many problems, in particular due to photobleaching and because the narrow absorption bands make it difficult to excite the different colours at once. Dye emission can also be broad, making multicolour imaging difficult.

Previous attempts to utilise luminescent quantum dots for tagging applications have more recently been based principally on semiconductors, with luminescence of various colours being generated by transitions across the quantum confined semiconductor band gap. The size of the nanoparticles governs the wavelength of the emission. This approach has a number of significant drawbacks:
(i) Semiconductors with suitable bulk band gaps are based on materials such as group III/V or group II/VI materials. Typically, CdSe or CdS are used. These materials are toxic, and synthesis is generally carried out in organic solvents. Therefore, phase transfer to water is required after they have been prepared. This is technologically difficult to carry out while maintaining luminescence efficiency. Quantum dots which can be formed in water remove a significant barrier to synthesis.

(ii) If semiconductors are used then size selection must be used to separate material of different emission wavelengths. This leads to a substantial loss of material for a single synthesis run while requiring an additional step which involves the use of specialist equipment.

(iii) Typical semiconductor materials are toxic, and their precursors may be highly toxic. Also they are frequently air/moisture sensitive.

(iv) To make highly luminescent particles requires a further shell of semiconductor and often a further shell of silica.

There is therefore a need for water-soluble quantum dot materials (generally ≦100 nm) which are non-toxic and which can be prepared efficiently without the need for specialist apparatus.

It has now been found, according to the present invention, that it is possible to use generally rare earth-containing particles which can overcome the majority of the problems encountered with semiconductor quantum dots. In particular, generally they can be easily prepared, are not sensitive to atmospheric degradation and the emission colour is dependent upon the constituent rare earth ion and not the particle size.

According to the present invention there is provided a process for preparing water soluble particles of a luminescent material which is a rare earth material, a doped compound semi-conductor or a doped inorganic compound which comprises coating particles of said luminescent material either during the production of the particles, or subsequently, with an organic acid or Lewis base such that the surface of the coating possesses one or more reactive groups, typically an —SH, —COOH, —OH, amino or amido group.

The rare earth materials which can be used in the present invention include compounds where the rare earth is part of the lattice, as in rare earth oxides of the formula Ln₂O₃, hydroxides, tungstates, molybdates or uranyl compounds as well as inorganic compounds where the rare earth metal is a dopant, as in doped oxides, including, for example, Y₂O₃:RE, where RE is a rare earth, such as europium, and mixed oxides, as well as phosphors including rare earth doped fluorides, such as alkaline earth metal fluorides e.g. CaF₂, SrF₂, BaF₂ and (LaAlCe)F₃ and LiYF₄ e.g. LiYF₄:Eu, oxyhalides, such as YOCl and LaOCl, borates such as ScBo₃, YBo₃, LaBo₃, CeBo₃ and YAl₃B₂O₁₂, aluminates such as Y₂Al₈O₁₂, Y₃Al₅O₁₂, e.g. Y₃Al₅O₁₂:Eu, Y₄Al₂O₉, silicates such as Sc₂Si₂O₇, Y₂Si₂O₇ and Ce₂Si₂O₇, and phosphates such as YPO₄, LaPO₄, CePO₄ and GdPO₄, as well as oxysulphides, tungstates, vanadates, such as YVO₄ e.g. doped with dysprosium or europium molybdates and uranyl compounds. These inorganic compounds can also be doped with other dopant metals. Other dopant metals which can be used include those in the first row of transition metals in the Periodic Table including Mn, Cu and Cr, as well as alkaline earth metals i.e. Group IIA of the Periodic Table such as Ca and Sr along with Group IIB, IVB and VB, such as lead, tin and antimony. These can be used with semi-conductors (see below e.g. ZnS:Ca) and inorganic compounds (including rare earth compounds). One of skill in the art knows what inorganic compounds can be doped to provide luminescent materials. By way of example, manganese can be doped into BaMgAl₁₄O₂₃, calcium or magnesium fluoride, metal oxides such as calcium and titanium oxides, cadmium or zinc phosphate, magnesium, zinc or calcium silicates, strontium aluminates and cadmium borates as well as semi-conductors such as those of formula ME (M=Zn, Cd, Ca, Sr, Mg, Ba; E=S, Se, Te. Manganese, and other dopants, can be used in conjunction with other dopants (co-activators), such as As, Ce, Pb, Sb, Sn and Tb. Chromium can be doped into, for example, zinc gallates, GaAs, and Al₂O₃ while copper can be doped into, for example, ME (M=Zn, Cd, Ca, Sr, Mg, Ba; E=S, Se Te). Mixed dopants and up-conversion phosphor materials can also be used. Other materials which can be doped with rare earth metals include sulphates such as calcium sulphate, which are typically doped with, for example, dysprosium or europium as well as compound semi-conductors e.g. ZnS or other group II/VI or group III/V semi-conductors as in ZnS:Eu. Unlike the use of compound semi-conductors themselves the emission of the doped material is independent of particle size. Thus suitable rare earth metals which can be used in the present invention include, europium, terbium and cerium as well as yttrium, scandium, lanthanum and gadolinium. Suitable doped oxides which can be used in the process of the present invention include those disclosed in, for example, WO9946204A which have the formula: Z₂O₃:Z^{x+} where Z is a rare earth metal and x is from 2 to 4 and, especially, Tb₂O₃:Tb and Eu₂O₃:Eu. Other suitable phosphors include those described in WO0036050A, WO0036051A and WO0071637A which can be prepared by doping a host oxide with a rare earth, providing compounds of the formula: Z₂O_{y}:RE and Z_{z}XₓO_{y}:RE where Z is a metal of valency a, X is a metal or metalloid of valency b such that 2y=a.z or 2y=a.z+b.y and RE is a rare earth dopant ion or manganese.

Typically Z is yttrium, gadolinium, gallium or tantalum and X is aluminium, silicon or zinc. RE is typically terbium, europium, cerium, thulium, samarium, holinium, erbium, dysprosium or praseodymium.

As indicated, the process of the present invention involves coating or capping the particles with a particular organic acid or Lewis base (which is generally polar) including polymeric and dendritic materials. These materials must possess a surface reactive group which can subsequently be involved in coupling reactions to produce a biotag. In general, it is necessary for the acid or base to possess two different functionalities, one as discussed above for subsequent coupling and the second to secure the ligand to the particle.

In one embodiment preformed water-soluble particles which are already capped are subjected to reaction in water whereby the desired acid or base replaces an existing capping agent. Alternatively, the desired capping agent can be secured during the formation of the particles, for example as described in WO9946204A where the metal complexing surface active molecule is one which is chosen to possess the desired functional groups.

For the particle to be water soluble, it is necessary to select a metal complexing surface active molecule which possesses groups which water solubilise the particles. Such groups include —OH, —COO⁻ and —NH₃⁺. In the first embodiment, an aqueous solution of the particles is prepared and the desired acid/Lewis base is added. This generally results in a precipitate of the particles coated with the acid/Lewis base. It is preferred that the particles are already coated, for example with an organic acid or Lewis base which does not possess the desired surface reactive groups. Such particles are typically prepared as described in WO9946204A. Thus to a solution of the rare earth metal salt such as a chloride is added a metal complexing surface active molecule which has a surface capping effect, such as trioctyl phosphine oxide (TOPO) or sodium hexametaphosphate, and then alkali is added which results in the oxide being formed as a colloidal precipitate.

It will be appreciated that in order for the reactive group-containing coating agent to replace the existing coating it is necessary to select a coating agent which binds more strongly to the metal particles than the existing coating agent. One of skill in the art does, of course, know how to achieve this; for example phosphine oxide (as in TOPO) binds relatively weakly compared with thiol so that TOPO can generally be largely replaced by a thiol-group containing capping agent. Clearly the initial capping agent should be selected with these considerations in mind.

In the second embodiment a process such as that disclosed in WO9946204A can be used employing an organic acid or Lewis base which possesses the required reactive groups. Thus alkali or base is added to a solution of a rare earth metal salt, typically a chloride, in the presence of the necessary capping agent. The purpose of increasing the pH is to maintain the correct anion/cation ratio in the precipitated material. In general, the pH should be at least 8 and typically 8 to 10, for example 8 to 9. The surface active molecule binds to the rare earth ions and acts to passivate any surface state which may allow for non-radiative recombination. It thus has a surface capping effect. A typical reaction using a polymer to provide the particles with surface carboxyl groupings which are capable of coupling (with the phosphonic groups binding to the particle) is shown below: 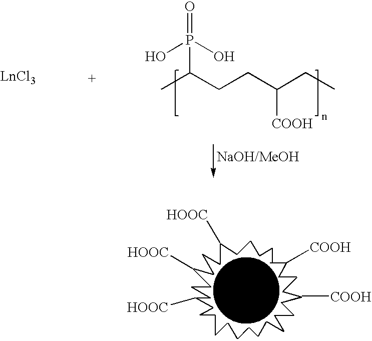
A similar process can be used to prepare other capped particles of the present invention. For example, particles of a compound of the formula: X(YOₐ)_{b} wherein X is a rare earth metal, a metal of Group IIA or B of the Periodic Table or lead, or a mixture of two or more thereof, Y is a metal which forms an anion with oxygen, or a mixture of two or more thereof, and a and b are such that the compound is stoichiometric, the particle having a size not exceeding 100 nm can be prepared by mixing an aqueous solution having a basic pH of a compound containing an anion of Y and a surfactant, with an aqueous solution of a compound containing a cation X. Further details can be found in our British application No. 0126284.9 (our N.83807).

It will be appreciated that if the coating provides surface —COOH⁻ groups, a base needs to be added to convert these groups into water-solubilising —COO⁻ groups. Likewise with surface amino groups, an acid such as HNO₃ needs to be added to convert the groups into water-solubilising —N⁺ groups. With a polymer, though, such conversions may be unnecessary in that it is likely that at least some of the other groups present will provide water-solubilising groups. For example excess P(O)(OH)₂ side chains not bound to the particle surface can point out into the water making the dot water soluble.

For the ligand/surface active molecule to be effective it must be able to stick to the particle surface. Typically compounds which can achieve this include phosphines, phosphine oxides, thiols, amines, carboxylic acids, phosphates, sulfonic acids, sulfinic acids, phosphoric acids, phosphonic acids, phosphinic acids, crown ethers and mixtures of these.

The ligand itself can be monodentate (i.e. with a single binding point, e.g. a trialkylphosphine oxide e.g. with a chain length of 4 to 20 carbon atoms), bidentate (e.g. dihydrolipoic or a dialkyl sulphosuccinate e.g. sodium dioctyl sulphosuccinate with a similar chain length to monodentate) or multi dentate (polymer/dendrimers with pendant side groups such as phosphines, phosphine oxides, thiols, amines, carboxylic acids, phosphates, sulfonic acids, sulfinic acids, phosphoric acids, phosphinic acids and mixtures of these).

As indicated above, the ligand also requires a further functional group for biocoupling reactions, including carboxylic acids, amines, amides, thiols and hydroxy groups. These may be at terminal points in the molecule, or as a side chain, and there may be more than one. In monodentate/bidentate ligands these functionalities may also be protonated/deprotonated to make the ligand water-soluble.

The ligand can also be polymeric i.e. a polymer possessing the desired groups. Typically, therefore, copolymers can be used derived from, for example, a vinyl carboxylic acid such as acrylic acid and a vinyl monomer possessing a group capable of binding to the particles such as vinyl phosphonic acid.

The ligand needs to be water soluble. If necessary, therefore, the molecule may contain other groups which assist solubility such as hydroxy and deprotonated acid or protonated amine groups. Thus if a polymer is used it may have side chains that make the ligand water soluble, e.g. hydroxy groups, deprotonated acids or protonated amines.

Other water-soluble ligands which can be used include sugar molecules, including oligosaccharides, monosaccharides, and polysaccharides which are water-soluble and contain side groups for further biocoupling reactions such as hydroxy groups as well as amine phosphates, typically nucleoside phosphates such as adenosine and guanosine phosphates including ATP (adenosine 5′-triphosphate), ADP (adenosine diphosphate), AMP (adenosine monophosphate) and GMP (guanosine monophosphate). Cyclodextriris (cyclic oligosaccharides), functionalised with phosphines, phosphine oxides, thiols, amines, carboxylic acids, phosphates, sulfonic acids, sulfinic acids, phosphoric acids, phosphinic acids and mixtures of can also be used.

It is known that certain metals bind well to certain groups. Accordingly a molecule containing such a group will bind to that metal via this group, leaving the other group (or groups) free for a biocoupling reaction. Thus in many cases a thiocarboxylic acid will coat the particle with the carboxylic grouping on the surface as the thiol group has a stronger affinity for the metal(s) in the particle. Chemical and spectroscopic tests can be made, if necessary, to determine how the capping agent is oriented.

The particles, to be effective for biotagging, should not be too large. In general the particle size should not exceed 10 microns. There is no lower limit. Thus a typical size range is from 1 nm to 10 microns e.g. 10 nm to 1 micron.

In order to bind the particle to the moiety to be tagged use is made of a binding interaction between the moiety and a molecule attached to the particle involving a ligand binding pair. Typically such an interaction is a high affinity non-covalent coupling interaction between a moiety and a molecule able to bind to each other in physiological and/or cellular conditions. The binding may be reversible or non-reversible binding.

In one embodiment the moiety itself is the substance which it is desired to tag, and in this case the moiety will be in a non-modified form, i.e. in its naturally occurring form. In other embodiments the moiety is attached to the substance which it is desired to tag.

One or both of the moiety and molecule on the particle may be a protein or polynucleotide. Typically one or both of the moiety and molecule are naturally occurring substances, such as substances found in living organisms, for example prokaryotes and/or eukaryotes. In one embodiment the moiety and molecule are substances which may bind each other when present in their natural locations, such as a receptor ligand pair.

A wide range of moieties can be tagged in this way, for example any cellular component, for example membrane-bound, in the cytoplasm, either extra-cellular or intra-cellular. Moieties which move from one cellular location to another are particularly useful. The moieties can be present within an organelle, for example in the mitochondria or nucleus. They are typically proteins, polynucleotides, carbohydrates or lipids.

Examples of suitable ligand receptor binding pairs include:
transforming growth factor (TGF) and transforming growth factor receptor (TGFR) or EGF Receptor (EGFR);
epidermal growth factor (EGF) and EGFR;
tumor necrosis factor-.alpha. (TNF-.alpha.) and tumor necrosis factor-receptor (TNFR);
interferon and interferon receptor;
platelet derived growth factor (PDGF) and PDGF receptor;
transferrin and transferrin receptor;
avidin and biotin or antibiotin;
antibody and antigen pairs;
interleukin and interleukin receptor (including types 3, 4 and 5);
granulocyte-macrophage colony stimulating factor (GMCSF) and G,4CSF receptor;
macrophage colony stimulating factor (MCSF) and MCSF receptor; and
granulocyte colony stimulating factor (G-CSF) and C-CSF receptor.

When the moiety is any of the first mentioned substances in the above pairs then the molecule is generally the second mentioned substance and conversely when the molecule is any of the first mentioned substances then the moiety is generally the second mentioned substance. In the case of the antibody/antigen pair the antigen may be a protein or non-protein antigen. The antigen may be digoxigenin or phosphotyrosine.

As mentioned above both the molecule and moiety may be polynucleotides. In this case typically the polynucleotides are single stranded and able to bind to each other by Watson-Crick base pairing, i.e. they are partially or wholly complementary.

It will be appreciated that the reactive groups on the surface of the particle are selected such that one member of the pairs will react with the particle, either directly or with the aid of a crosslinking agent. These are standard reactions well known to those skilled in the art. For example, bovine serum albumin can be tagged with amino acid-coated phosphors using glutaric dialdehyde.

The following Examples further illustrate the present invention.

### EXAMPLE 1

ATP (adenosine 5′-triphosphate, disodium salt hydrate) (0.44 g, 7.98×10⁻⁴ M) and sodium tungstate (0.33 g, 1×10⁻³M) were dissolved in 100 ml deionised water. The pH was altered to 8.5 using aqueous sodium hydroxide solution To this was added a solution of europium chloride hexahydrate (0.37 g, 1×10′ M, 50 ml water). dropwise, whilst the pH was maintained above 8.5 using aqueous sodium hydroxide. Once the salt had been added, the solution was allowed to stand for ca. 1 hour, and then centrifuged to remove any precipitates. To the clear solution was added 200 ml acetone/propanol (1:1, volume) causing a precipitate. The precipitate was dried in vacuo and stored under an inert atmosphere.

### EXAMPLE 2

Terbium chloride hexahydrate (TbCl₃.6H₂O, 0.88 g, 2.35×10⁻³ M) and a copolymer of acrylic acid and vinyl phosphonic acid (2 g, in 10 mls water, Albritect 30 from Rhodia) were dissolved in 1 litre of methanol. The pH was adjusted to 5.5 using aqueous NaOH solution (0.1 M). Upon addition of the NaOH solution, a precipitate started to form. The solution was allowed to stand for 40 minutes, and the precipitate was isolated by centrifugation.

### EXAMPLE 3

Europium chloride hexahydrate (0.0437 g, 1.2×10⁻⁴ M) and a copolymer of acrylic acid and vinyl phosphonic acid (0.2 g in 1 ml water, Albritect CP30) were dissolved in 100 ml methanol. The pH was adjusted to 5.4 using NaOH solution, initiating precipitation. This was allowed to stir for 30 minutes, and then isolated by centrifugation.

1. A process for preparing water soluble particles of a luminescent material which is a rare earth material, a doped compound semi-conductor or a doped inorganic compound which comprises coating particles of said luminescent material, either during production of the particles, or subsequently, with an organic acid or Lewis base such that the surface of the coating possesses one or more reactive groups.

2. A process according to claim 1 wherein the reactive groups are —SH, —COOH, —OH, amino or amido groups.

3. A process according to claim 1 or 2 wherein the rare earth material is a rare earth metal oxide or an inorganic compound which has been doped with a rare earth element.

4. A process according to any one of the preceding claims wherein the rare earth metal is europium, terbium, cerium, yttrium, scandium, lanthanum or gadolinium.

5. A process according to any one of the preceding claims wherein the doped material is a doped rare earth oxide of the formula Z₂O₃:Z^{x+} where Z is a rare earth metal and x is from 2 to 4.

6. A process according to any one of claims 1 to 4 wherein the inorganic compound is a rare earth metal oxide, a fluoride, oxyhalide, borate, aluminate, silicate, phosphate, vanadate, oxysulphide, tungstate, molybdate or uranyl compound.

7. A process according to claim 1 or 2 wherein the dopant of the doped compound semi-conductor or inorganic compound is a rare earth material or a first row transition metal or a Group IIA metal of the Periodic Table.

8. A process according to claim 7 wherein the dopant is a rare earth metal as defined in claim 4, manganese, copper, chromium, calcium or strontium.

9. A process according to claim 7 or 8 wherein the compound semi-conductor is a Group II/Group VI or Group III/Group V semi-conductor.

10. A process according to any one of the preceding claims wherein the coating is applied to a preformed rare earth material which possesses a surface coating of an organic acid or Lewis base and a coating of a water soluble organic acid or Lewis base to provide the reactive group on the surface of the particles is applied from aqueous solution.

11. A process according to any one of claims 1 to 9 wherein the coating is applied during the production of the particles.

12. A process according to claim 11 for the production of particles as claimed in claim 5 which comprises adding a metal surface active molecule which has a surface capping effect to a solution of a rare earth metal salt and adding alkali so as to cause a colloidal precipitate to form.

13. A process according to any one of the preceding claims wherein the coating is a ligand which is monodentate, bidentate or polydentate.

14. A process according to claim 13 wherein the ligand is a trialkylphosphine oxide, or a dialkyl sulphosuccinate, a polymer possessing phosphonic and carboxylic acid groups, or a nucleoside phosphate.

15. A process according to any one of the preceding claims wherein the particles have a size which does not exceed 10 microns.

16. A process according to claim 15 wherein the particles have a size from 10 nm to 1 micron.

17. A process according to claim 1 substantially as described in any one of the Examples.

18. Water soluble particles of a luminescent material whenever prepared by a process as claimed in any one of the preceding claims.

19. Water soluble particles of a luminescent material which is a rare earth material, a doped semi-conductor or a doped inorganic compound, possessing a coating with one or more reactive groups on the surface of said coating.

20. Particles according to claim 19 wherein the reactive groups are —SH, —COOH, —OH, amino or amido groups.

21. Particles according to claim 19 or 20 which are of a rare earth material.

22. Particles according to claim 21 which have one or more of the features of claims 3 to 5.

23. Particles according to claim 19 or 20 which are of a Group II/Group VI or Group III/Group V semi-conductor.

24. Particles according to claim 19 or 20 which are of a doped inorganic compound.

25. Particles according to claim 23 or 24 which have one or more of the features of claims 6 to 8.

26. Particles according to claim 19 of Tb₂O₃ or Eu₂O₃ coated with a copolymer of acrylic acid and vinyl phosphonic acid.

27. Particles according to claim 19 of europium tungstate coated with adenosine 5′-triphosphate.

28. A biotag which comprises particles as claimed in any one of claims 18 to 27 attached to one member of a ligand binding pair.

29. A biotag according to claim 28 wherein the ligand binding pair is avidin and biotin or an antibody or an antigen.

30. A biotag according to claim 28 substantially as hereinbefore described.

31. A process for tagging a moiety which comprises attaching a biotag as claimed in any one of claims 28 to 30 either directly or after attaching to said moiety the other member of said ligand binding pair.

32. A process according to claim 31 wherein the biotag is produced with the aid of a cross linking agent.

33. A process according to claim 31 substantially as hereinbefore described.
